(19) United States
(12) Patent Application Publication
(10) Pub. No.: US 2008/0061461 A1
(43) Pub. Date: Mar. 13, 2008

(54) Methods to Improve Yields on a Metal Substrate Extrusion Polymer Coating Line

(76) Inventor: Mark V. Loen, Maricopa, AZ (US)

Correspondence Address: LOEN PATENT SERVICES, 43649 W BAILEY DRIVE, MARICOPA, AZ, 85239, US

(21) Appl. No.: 11/852,525

(22) Filed: Sep. 10, 2007

Related U.S. Application Data
(60) Provisional application No. 60/825,123, filed on Sep. 9, 2006.

(51) Int. Cl. B29C 47/06; B32B 15/04; B29C 47/92

(52) U.S. Cl. 264/40.1; 264/171.14; 264/171.22

(57) ABSTRACT

Methods to improve the substrate yield for a flat metal substrate extrusion coating line are described. The improvements in metal substrate yield is achieved by providing additional equipment to measure the polymer thickness and inspect the polymer curtain in the off line condition and make appropriate corrections before the flat metal substrate is coated.

### CROSS REFERENCE TO RELATED APPLICATIONS

This application claims the benefit of U.S. Provisional Application No. 60/825,123 filed on Sep. 9, 2006.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

The current invention is directed toward yield improvements on a metal coating line. In particular, the methods are directed toward an extrusion coating line on thicker metal substrates. The methods are appropriate for continuous or batch coating lines for flat metal substrates, such as aluminum or steel strip. The strip is generally wound into a coil for compact storage and then unwound on a processing line for coating.

(2) Description of Related Art

Extrusion coating on thicker, flat metal substrates is not a well known art; this new process is in its infancy. The processing methods required for coating flat metal substrates, above 0.004″ thick, are substantially different than coating metal foils, film, or paper. Even though the extrusion equipment used for coating is similar, different processing steps are required to develop marketable adhesion and coating quality. The process of extrusion coating metal substrates above 0.004″ thick presents unique problems. Established equipment and processes in the existing extrusion coating industry need to be adapted and modified for commercial success. For thicker metal substrates, the demands upon the coating are unique for adhesion, scratch hardness, corrosion resistance, weatherability, thickness, and color uniformity.

Thicker metal substrates are used in completely different markets than thin metal substrates. A typical aluminum foil application would be a convenience food bag, such as a potato chip bag, and a thick metal panel might be used as an outdoor roofing panel. It is readily apparent, therefore, that the demands upon the coating properties are unique for each application. It is also immediately apparent that the unique properties needed would also involve different polymer properties, different types of metal, different metal thicknesses, and require different processing steps to create them.

One significant commercialization problem facing this new industry are high yield losses due to the initial difficulties in achieving commercial thickness tolerances across the width of the metal. Unacceptable yield problems arise when conventional methods of adjusting the extrusion slot die are applied to thicker metal substrates. Customary extrusion coating practice on foils, cardboard, and paper provide for the machine to be “lined out” under actual operation. That is, the thickness uniformity across the width is adjusted within commercial tolerance while the line is running. This operation, when performed on line, will create off specification material that has to be scrapped. When foils, cardboard, or paper materials are scrapped, this yield loss is an acceptable financial loss.

Thicker metal substrates have a completely different financial situation. The yield loss incurred while the coating process is “lined out” presents a significant and unacceptable financial loss. The cost of a linear foot of metal substrate may be 5 to 30 times the cost of a linear foot of coating material, and partly depends upon the thickness of metal substrate. For valuable substrates, such as aluminum or stainless steel, the comparable substrate cost may be even higher.

Current methods of “lining out” the coating equipment consists of making adjustments to the extrusion die opening to create a uniform coating thickness as measured on the substrate after it is coated. For a thick metal, a typical commercial thickness tolerance is less than 10% variation across the width, and preferably is less than 5%. The adjustment to these tolerances may be a manual method or by an automatic control system. Automatic and manual adjustments of the extrusion die opening are a well known art and commercial equipment is readily available.

The time required for adjusting the coating to achieve a commercially acceptable coating tolerance is difficult to define with precision. It depends upon the actual die condition, the timeliness of a thickness measurement, maintenance of the die, the distance from the die to the thickness sensor, the length of time for an operator (or automatic control) to adjust the die, the temperature control at the die, and the flow characteristics of the polymer. From an automated control standpoint, a correcting system will take from one to four time constants to provide significant correction. The time constant includes sensor measuring delays, process response, and adjustment timing.

The timing to complete the adjustment is primarily dependent upon three time constants in the system. The first time constant comes from the film measurement. A typical measuring speed of film thickness is 2 inches per second. A sixty inch wide substrate will therefore require a minimum of 30 seconds for scanner to complete one pass over the coating. The second time constant comes from the length of time it takes for coated metal to reach the sensor at production speed. This may be relatively short: a 100 foot distance between the metal-polymer contact point and the sensor will be covered in 15 seconds at 400 fpm. The third time constant is the adjustment of the die bolts, which in turn, adjust the die opening. The die bolt adjustment is generally done automatically by thermally adjusting the length of an adjusting bolt, and the time constant is typically two to three minutes. Altogether, the time constant of the control system is about three or four minutes.

Due to these factors, in actual practice the polymer thickness measurement and adjustment may require four to twenty minutes under good operating conditions to achieve a commercial, across the width, thickness variance. If this correction is performed during a production run, the yield loss may easily approach 25% of the length of a first production coil, or more, depending upon line speed. A run of like coils and coatings, i.e. a lot size, is likely to be less than four coils. Financially, the initial yield loss is highly unacceptable. It is unacceptable even when considering all of the coils run in sequence and the initial loss is not repeated in subsequent coils in a production run.

For a thicker metal substrate, there are production issues not commonly seen on other extrusion production lines. During a typical weekly production run, there are significant changes in commercial orders. The substrate width varies, the coating thickness varies, the line speed varies, the polymer type varies, and there are frequent color changeovers. Any of these changes are likely to create a new flow pattern in the extrusion die, particularly at the die edges. The frequent changes on a production line require adjustments by the thickness control system to maintain commercial thicknesses. Substrate yields will be higher if significant coating thickness variances are adjusted off line for a particular order.

In addition, it is preferable to have the capability to adjust the coating thickness off line when there are maintenance or control issues to resolve that are related to the coating thickness. It is financially punishing to stabilize a control system when coating a prime metal substrate.

Initial thickness variances for extrusion coating are routinely on the order of 10 to 20% in localized areas, as seen in the laboratory. It is not considered unusual for a maximum thickness variance to be off by as much as 50% in some localized areas, particularly at the edges where polymer neck in is an issue. This is a significant error that will take a significant time to correct with good equipment in proper working order.

The actual financial impact of yield loss depend upon how fast the line operates while the line is adjusted, how long the adjustment takes, the number of coils that can be run consecutively once the adjustment is complete, the thickness of the metal substrate, and other factors. Overall production substrate yield losses up to 10 percent are expected if the adjustment is performed on line verses off line.

Many important details and features related to general processing steps for a metal substrate extrusion coating process are further described in U.S. Pat. No. 5,407,702, U.S. Pat. No. 5,919,517 and U.S. patent application Ser. No. 10/233,369. The particular processing steps in each patent vary and include other important features unique to each system. These patents generally refer to necessary processing steps to achieve a coating with a level of adhesion, but do not consider the many, and varied, technical and operational issues related to actual commercial implementation. There are no commercial metal substrate extrusion coating lines in North America due to the many technical and business issues remaining to be resolved. None of the patents just listed consider the important problem addressed by this invention.

### BRIEF SUMMARY OF THE INVENTION

An improvement in yield for an extrusion coating line can be achieved by providing additional equipment to measure the polymer thickness in the off line condition. This additional equipment would include an offline sensor measuring the polymer in the molten state just below the die lips, or a sensor on a movable cast sheet line that is added to the commercial production process. If the film is solidified, there is an additional opportunity to pre-inspect the film for quality before actual production is initiated.

### BRIEF DESCRIPTION OF THE SEVERAL VIEWS OF THE DRAWING(S)

FIG. 1 illustrates thickness measurement directly on the film as it exits the extrusion die when the extrusion die is “off line.”

FIG. 2 illustrates thickness measurement by creating a second, cast film line next to the primary coating line where the measuring station is designed to be mobile and moves out of the way when the extruder carriage is positioned to coat metal substrate.

FIG. 3 is a simplified block diagram of an automated control system that allows for two different thickness sensors to adjust a single die.

FIG. 4 is a line speed chart that shows how the production line is ramped up to production speed and illustrates the advantage of the present invention.

### DETAILED DESCRIPTION OF THE INVENTION

As previously described, yield improvements on a metal substrate extrusion coating process is the main object of the present invention. It is important to define the extrusion coating process as related to the present invention. A flat metal substrate extrusion coating process is generally described as a process that includes the following three processing steps:
1. Preparing a flat metal surface for coating by surface treating and optionally preheating the metal substrate that is at least 0.004″ thick.
2. Extruding a molten film onto the metal surface by use of a slot die and pressing the molten film against the flat metal substrate.
3. Post treating by re-heating the coated metal substrate and cooling.

The extruded film is primarily a thermoplastic. It may be provided in a multiple layer structure. It may include various polymers, adherents, adhesive compounds, colors, and additives to provide important properties.

The extruded thermoplastic film may be of varying thicknesses, and the preferred embodiment is a thickness range from 0.2 mils to 5.0 mils.

In a preferred embodiment, the metal substrate is primed with a suitable coating for improved corrosion resistance. Various corrosion products may be applied that are known in the art, and particularly include chromium based compounds. Tinplate, for example, utilizes chromium oxide for improved performance. Other primers in the construction industry are utilized, and include iron, zinc, and phosphate compound coatings. Priming would include compounds that are known to passivate the metal surface. The metal substrate is typically steel, aluminum, copper, or titanium.

In a preferred embodiment, the metal substrate may have an external metallic coating including chrome, zinc, and aluminum, that are known in the art.

The term “thin thermoplastic extrusion coating” means a coating which comprises primarily a polymer thermoplastic with a final thickness less than 0.005″ that is coated on a flat metal substrate by a metal substrate extrusion coating process.

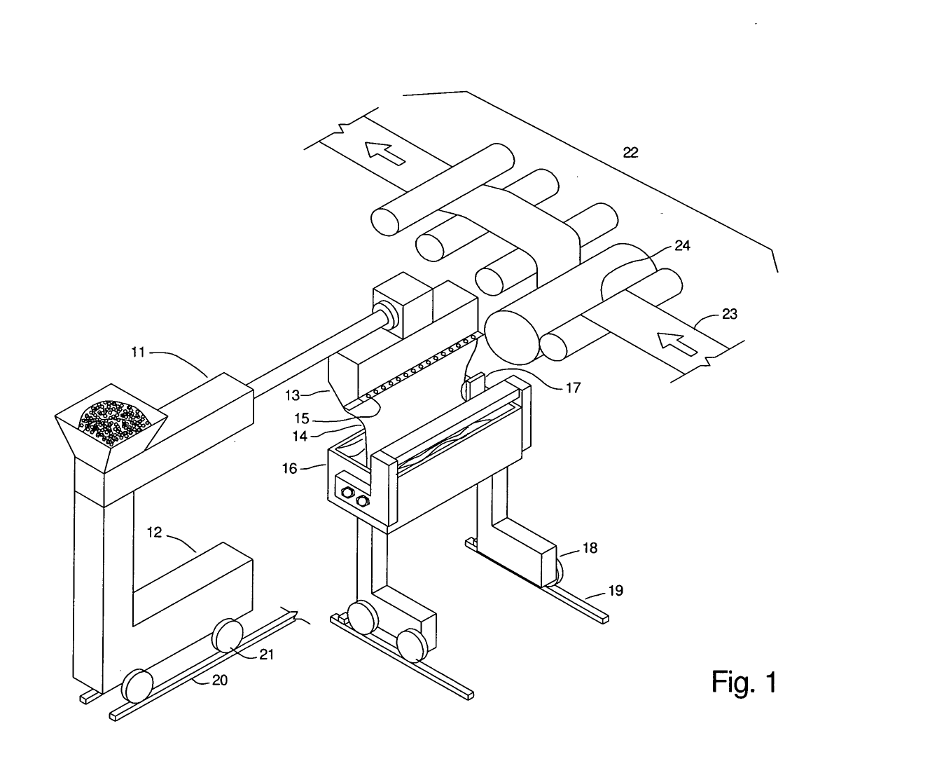

FIG. 1 illustrates thickness measurement directly on the film as it exits the extrusion die when the extrusion die is “off line.” An extruder die 11 is mounted on a mobile carriage 12 and sits on a rail 20 and wheel 21 system where it may move along the rail 20 in either direction by a motor (not shown) which rotates the wheel 21. The extruder 11 melts a thermoplastic and forces it through heated piping into a slot die 13 where a molten curtain 14 is extruded. Adjustment bolts 15 across the width of the slot die 13 are used to make corrections to the die slot opening, and therefore, adjust the local thickness of the molten curtain 14 as it exits the slot die 13. A polymer catch pan 16 is wheeled into place by a second wheel 18 and rail system 19, which may be motorized or manual. A film thickness sensor 17 is attached to the catch pan and is designed to move across the film width. The film thickness sensor 17 is used to gauge how consistent the film thickness is across the width.

FIG. 1 illustrates only one extruder mounted on a movable frame. Multiple extruders may be used depending upon the coating structure. Also, different arrangements of a catch pan and sensor may be provided without departing from the scope and intent of this invention.

The thickness sensor may be a variety of types. A gamma ray back scatter or an infrared sensor are preferred embodiments. For accuracy, the sensor is less than six inches away from the film, and is preferably following manufacturer recommendations for proximity. The sensor may be moved manually or by an automatic system.

It is a preferred embodiment to measure the curtain thickness within close proximity to the slot die opening. Most polymer curtains have a significant amount of neck in and it is preferable for the measurement to be within 12 vertical inches of the slot die opening, and most preferably within 2-6 inches. The actual recommended distance depends upon the polymer(s) and molten film temperature.

The thickness sensor is likely to increase in temperature due to the nearness of the hot curtain. For longevity and accuracy, it is preferable for the sensor to be cooled by a water or air system. If necessary, the sensor may also have a calibrating position at either end of its travel across the curtain width to correct for any thermal drift. At the calibrating position, the sensor may be measuring a sample with a known thickness or perform a re-zeroing function.

In FIG. 1, the film measuring equipment and catch pan are put in place only temporarily, until the thickness is at an acceptable tolerance across the width, and then the system is moved out of the way. The extruder wheel 21 and frame 20 are then used to put the slot die 13 into the correct position for coating the metal substrate 23 at the nip point 24 on the extrusion coating line 22. Only a few rolls from the metal substrate extrusion coating line are illustrated to simplify FIG. 1.

The thickness across the film width is preferably displayed on a computer screen or other convenient operator display. Various computer and software features can be used to identify which zones are out of tolerance and how much correction is needed. The thickness sensor can be connected to a computerized control and the die adjustment can be made automatic by adding heaters to the adjustment bolts 15 in FIG. 1, as is known in the art. The needed die slot adjustments may be either manual or automatic.

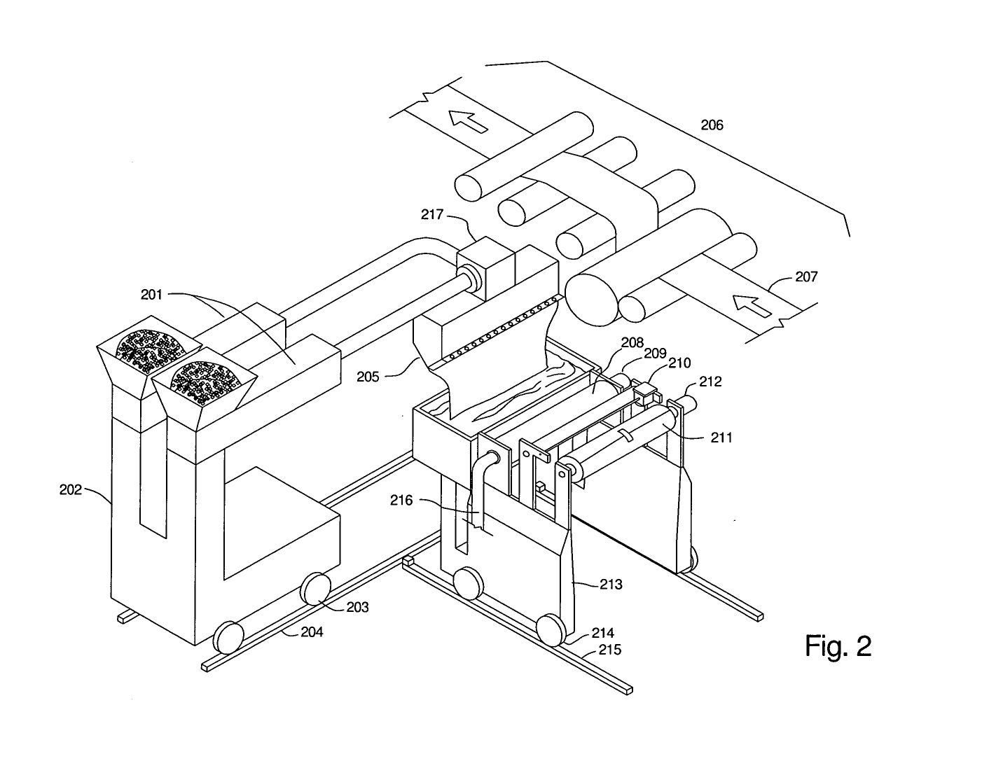

FIG. 2 illustrates a preferred embodiment where the polymer film thickness is measured by creating a mobile casting film section next to the metal substrate extrusion coating line.

A thickness measuring station is designed to be mobile and moves out of the way when the extruder carriage is positioned to coat metal substrate. Similar to FIG. 1, two extruders 201 are mounted on a movable frame 202 that is mounted on a wheel 203 and rail 204 system. The extruders 201 are connected to a combination block 217 which is bolted to a slot die 205. Nearby, a portion of a metal substrate extrusion coating line 206 is illustrated which coats a flat metal substrate 207.

A portable cast film section is mounted on a movable frame 213 that is mounted on a wheel 214 and rail 215 system. The cast film section consists of a cooling roll 208 with end motor 209, a thickness sensor 210 that traverses the film width, and winding reel 211 with end motor 212. Water cooling piping 216 for the cooling roll 208 is illustrated without details, such as a rotary coupling, since this is known in the art. The cooling roll motor 209 may be speed controlled and the winding reel motor 212 may be torsion or current controlled to provide an even film tension.

Simplified electrical control of the film tension and speed is preferable as an even thickness is normally desired, not an exact thickness. For example, the cooling roll motor 209 may have two or three speed setpoints rather than utilize a continuous speed regulation that requires a film speed sensor and a feedback control loop. The winding reel motor 212 may be on current control to provide a constant tension in the film without the need for a tensiometer roll and feedback control loop. Other simplified control schemes for tension and speed control in a short cast section are possible, and include motor torsion control, and motor speed control.

The actual film thickness on the cast film section can be controlled by the extruder speed(s) and the speed of the cooling roll surface. A nip roll may be added to the cooling roll if desired, but is not normally necessary. In some cases, it may desirable to measure the off line solidified film at a different thickness than the final thickness on the metal substrate.

The film thickness in the solidified state is measured by sensors that are well know in the art. Infra-red, gamma, beta, x-ray, mechanical, laser, light transmission, optical, reflective, and other types can be used depending upon the film type and the film thickness.

In a preferred embodiment, the goal of the off line thickness adjustment is to create a more uniform thickness. Alternately, a targeted thickness based on a predetermined thickness curve could also be the goal of any slot die adjustment. Such curves could be lines, parabolas, various polynomials, and other mathematical lines. A thickness variance across the width would generally be customer specified. The system described in FIGS. 1 and 2 are capable of creating such curves.

It is a distinct advantage to examine the extruded curtain for quality purposes in the solidified state. It is especially helpful to examine the curtain when it is thinned to approximate the final thickness on the metal substrate. Flaws in color consistency, imperfections in the curtain, minor pinholes, debris, die lines, gloss measurements, surface texture, and other quality defects are more readily seen, identified, and corrected. A careful and close curtain inspection in the off line position is a very helpful in correcting problems and improving substrate yield. In a preferred embodiment, the quality of the polymer curtain can be verified before the metal substrate is actually coated.

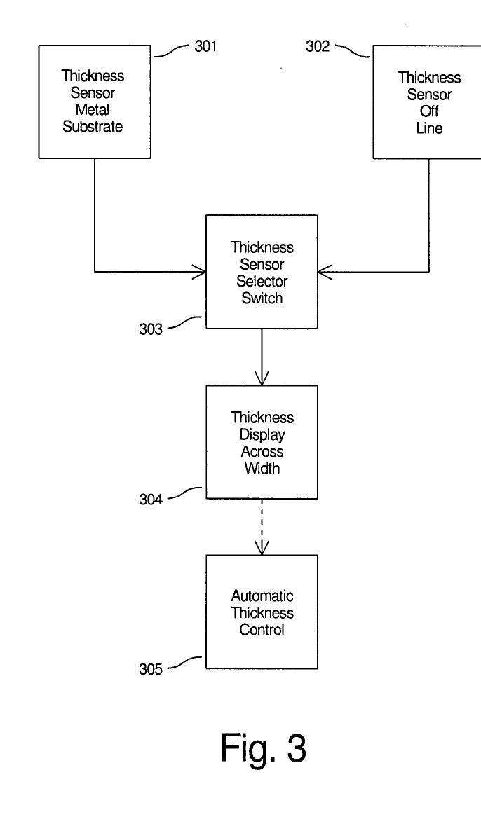

FIG. 3 is a simplified block diagram of an automated control system that allows for two different thickness sensors to adjust the die. An electronic switch or programming feature allows a computer to switch the display between two sensors. A polymer film thickness on the metal substrate sensor 301 is in parallel to the off line film thickness gauge 302. The off line thickness sensor 302 may be from the molten curtain or from a solidified film. Both of these sensors are sent to an electronic or programming means 303 where the operator selects which sensor to display 304. Alternately, the selection could be made automatic by adding position sensors to the extruder frame position. An operator would then make any necessary adjustments to the slot die opening manually, or allow an optional automated control 305 to make necessary corrections.

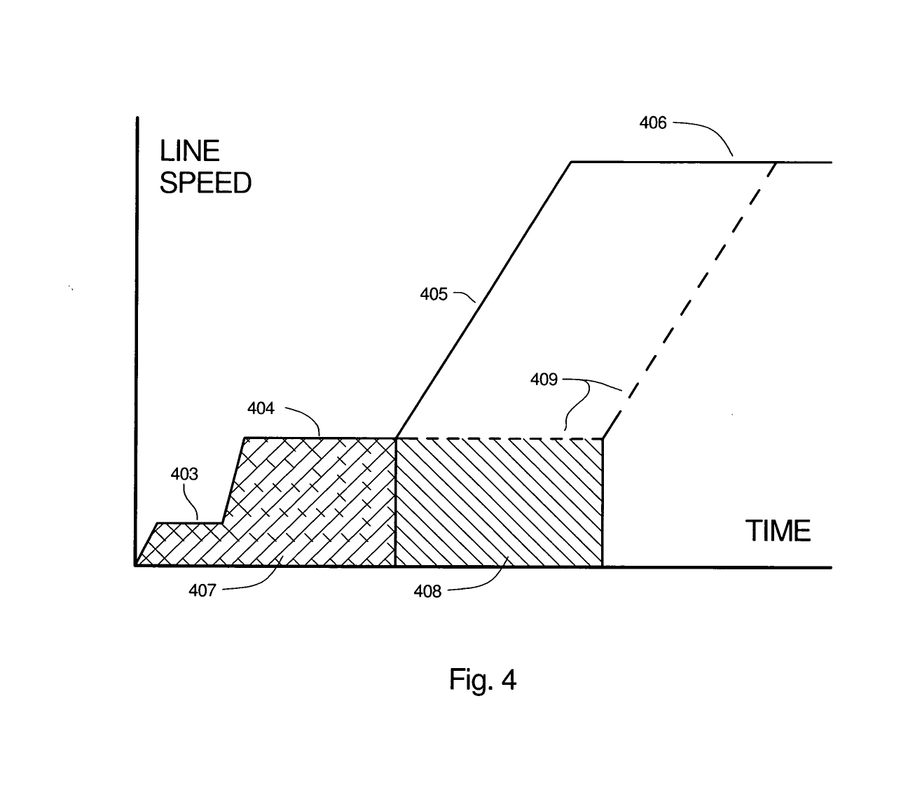

FIG. 4 is a line speed versus time graph showing the metal substrate extrusion coating line speed during threading, initial ramp up to gauge, and ramp up to production speed. The x-axis is time and the y-axis is line speed. Initially, the line is started by moving the metal substrate to an initial threading speed 403. At this speed, the extruders are moved to the coating position and the initial adhesion and contact between the polymer coating and the metal strip is secured. Various safety and operational interlocks in the line are activated during this time. The thread speed is normally maintained until pretreated metal arrives at the polymer-metal contact coating point. The surface flame treatment, corona pretreatment, and metal preheating are not normally operated while the line is stopped and achieve an initial stable operation during the threading time. The line speed is then ramped up to a coating verification speed 404 and the correct gauge, quality, and adhesion are certified across the metal width. This speed is usually somewhat higher than the thread speed as the polymer flow pattern in the slot die may vary significantly if the extruder speeds are too slow. Also, there can be polymer mixing problems if the extruders are at too a low speed. Verification of the gauge, adhesion, and polymer quality may take a substantial amount of time if the teachings of this invention are not practiced. The thickness gauge normally makes at least one pass to certify the gauge. As stated previously, the sensor motion is commonly 2 inches per second.

Once the coating is certified as acceptable for a production run, the speed is ramped up 405 to production speed 406. The ramp up 405 speed change is slower, at perhaps 1-10 fpm per second, in order to maintain an even coating thickness and proper polymer quality across the width. The ramp up speed is based on a number of factors, including extruder capacities, polymer throughput, equipment conditions, thickness measuring delays, polymer flow patterns at different extruder speeds, mixing shear in the extruders, neck in of the polymer, substrate conditions, etc.

The end result is that an amount of metal substrate is off specification and is a yield loss. The area 407 under the line speed curve illustrates the amount of substrate that is off specification when practicing this invention. The material is generally unsuitable for the desired application and is normally scrapped. The area 408 and alternate ramp up 409 production speed illustrates the additional scrap generated if the teachings of this invention are not practiced.

When the teachings of the present invention are followed, the prime coil yield loss area 408 in feet is less than 5% of the linear feet of the incoming production coil. In a preferred embodiment, the yield loss is less than 1 percent.

While various embodiments of the present invention have been described, the invention may be modified and adapted to various uses to those skilled in the art. Therefore, this invention is not limited to the description and figures shown herein, and includes all such changes and modifications that are encompassed by the scope of the claims. In particular, even though a one side coating is illustrated, the teachings of this invention are applicable to, and include a second side coating performed simultaneously, or sequentially, with the first coating.

I claim:

1. An improved flat metal substrate extrusion coating process comprising:
a. pre-treating said flat metal substrate by surface treating a major surface of said flat metal substrate and optionally preheating said flat metal substrate,
b. wherein said flat metal substrate is at least 0.004″ thick,
c. wherein said major surface is optionally primed prior to said surface treating,
d. extruding a molten film onto said major surface by the use of a slot die and at least one extruder,
e. pressing said molten film against said major surface, thereby creating a coated metal substrate,
f. post treating said coated metal substrate by re-heating and subsequently cooling said coated metal substrate,
g. adjusting said slot die prior to extruding said molten film onto said major surface, wherein said adjusting of said slot die improves the thickness consistency of said molten film to a predetermined criterion by utilizing at least one of the two following steps:
i) measuring said molten film thickness consistency while in the molten state and
ii) cooling and optionally thinning said molten film, and measuring said molten film thickness after solidification, and
h. wherein said molten film thickness consistency on said flat metal substrate rapidly achieves acceptable tolerance to a predetermined criterion, whereby the yield loss of said flat metal substrate on said flat metal substrate extrusion coating process is less than 5 percent.

2. An improved metal substrate extrusion coating process according to claim 1 wherein the measurement of said molten film thickness uniformity is measured within 12 inches of said slot die while said molten film is still in the molten state.

3. An improved metal substrate extrusion coating process according to claim 1 wherein said thickness consistency is based on a constant thickness across the width of the metal substrate.

4. An improved metal substrate extrusion coating process according to claim 1 wherein said thickness consistency is based on a mathematical curve across the width of the metal substrate.

5. An improved metal substrate extrusion coating process according to claim 1 wherein said yield loss of said flat metal substrate on said flat metal substrate extrusion coating process is less than 1 percent.

6. An improved metal substrate extrusion coating process according to claim 1 wherein said molten film is inspected for acceptable quality according to a predetermined criterion prior to extruding said molten film onto said major surface.

7. An improved metal substrate extrusion coating process according to claim 6 wherein said inspection for acceptable quality is performed on said molten film after it is thinned to the approximate desired final coating thickness on said flat metal substrate.
